(19) United States
(12) Patent Application Publication
(10) Pub. No.: US 2011/0150190 A1
(43) Pub. Date: Jun. 23, 2011

(54) EMERGENCY TELEPHONE

(76) Inventors: Ludovic Stauffer, Le Locle (CH); Daniel Perrenoud, Le Prevoux (CH); Jean-Paul Geissbuehler, Coffrane (CH); Markus Reis, Motier (CH); Markus Thuersam, La Chaux-De-Fonds (CH); Peter Theunissen, Beilstein (DE); Martin Frei, La Chaux-De-Fonds (CH); David Elter, Langenhagen (DE)

(21) Appl. No.: 12/970,320

(22) Filed: Dec. 16, 2010

(30) Foreign Application Priority Data
Dec. 21, 2009 (DE) 10 2009 055 096.8

(51) Int. Cl. H04M 11/04

(52) U.S. Cl. 379/37

(57) ABSTRACT

An emergency telephone has an emergency call button and is designed to place an emergency call to a target address when and/or after the emergency call button is actuated. The emergency telephone includes a housing that is designed to be opened and closed at least partially without the use of tools and/or in a non-destructive manner. The emergency telephone includes a memory device for storing functions and data and which is designed to be removed and reinstalled in the housing or to be replaced by a different memory device.

### CROSS-REFERENCE TO RELATED APPLICATION

The invention described and claimed hereinbelow is also described in German Patent Application DE 10 2009 055 096.8 filed on Dec. 21, 2009. This German Patent Application, whose subject matter is incorporated here by reference, provides the basis for a claim of priority of invention under 35 U.S.C. 119(a)-(d).

### BACKGROUND OF THE INVENTION

The present invention relates to an emergency telephone comprising an emergency call button, wherein the emergency telephone is designed to place an emergency call to at least one target address when the emergency call button is actuated.

The emergency telephone includes a housing which is designed to be opened and closed at least partially without the use of tools and/or in a non-destructive manner. It also comprises a memory device for storing functions and data. Furthermore, the invention relates to a method for removing and reinstalling a memory device in the emergency telephone, and a method for replacing the memory device by a different memory device in the emergency telephone.

Emergency telephones are generally known and are typically used in an emergency and/or a dangerous situation to transmit an alarm via a telephone network to an emergency call center or to a person who can provide assistance. Persons of advanced age or who require care, in particular, are provided with the capability to request help quickly and simply by pressing an emergency call button on the emergency telephone.

Publication DE100 2006 047 590 A1, which is the closest prior art, describes an easily cleaned keyboard device designed as an in-house emergency call device. The keyboard device comprises a housing having housing parts that are interconnected in a detachable manner. Thus, the keyboard device can be easily opened, thereby making it possible to access individual keys and/or the equipment inside the keyboard device. It is advantageous that the keyboard device is easy to clean.

### SUMMARY OF THE INVENTION

Accordingly, it is an object of the present invention to provide a method for removing and replacing a memory device in the emergency telephone, a method for replacing the memory device by a different memory device in the emergency telephone and a method which avoid the disadvantages of the prior art.

An emergency telephone comprising an emergency call button is provided within the scope of the invention. The emergency telephone is designed to place an emergency call to at least one target address when the emergency call button is actuated. Preferably, the emergency call button on the emergency telephone is designed to be highly visible e.g. it has an unusual size or color. In particular, the emergency call button is actuated by being pressed by the user. The user is often persons who are older, sick, or require assistance, but who would like to continue living independently while remaining confident that they can contact the target address at any time. The target address can be an emergency call center, administrative personnel who are in-house and/or at a station, e.g. in an assisted-living situation, or one of the user's caregivers. According to a possible embodiment of the invention, the emergency telephone comprises a microphone and a loudspeaker that can be used for communication between the user and the target address. It is also feasible to enable spoken messages to be output to the user via the loudspeaker e.g. in the form of voice mail.

The emergency telephone comprises a housing having a manageable size in particular. It is preferably designed to be mounted on a wall or placed on a surface. The housing can be opened and closed in an at least partially non-destructive manner. The housing preferably comprises an upper shell and a lower shell which can be separated and rejoined without the use of tools and/or in a non-destructive manner.

A keyboard system is fastened in the upper shell and is designed to be actuated from an outer side of the housing, in particular from the outer side of the upper shell. Typically, the keyboard system preferably comprises at least two, in particular at least four keys, and the emergency call button is one of the keys in the keyboard system. In particular, the emergency call button has a red color and/or a larger surface area than do the other keys in the keyboard system, thereby making it easily seen and/or felt by the user.

The keyboard system is designed to activate an electronic circuit system when or after the keyboard system is actuated. The electronic circuit system is preferably integrated in the lower shell and is not visible to the user when the housing is in a closed state. During and/or after activation of the electronic circuit system, which occurs in particular by the emergency call button being pressed, e.g. an automatic voice communication connection via a telephone network is established and/or an alarm signal is transmitted to the target address.

Furthermore, the emergency telephone comprises a memory device for storing functions and data. The emergency telephone is preferably designed to record functions and data and store them in the memory device. The functions and data are e.g. instructions and/or information regarding a use and/or operation of the emergency telephone, the user thereof, and/or the at least one target address. In particular, the memory device is integrated in the housing and is disposed in a region, preferably in the lower shell, which is made accessible by opening the housing without the use of tools and/or in a non-destructive manner.

According to the invention, the memory device is designed to be removed from and reinstalled in the housing, or to be replaced by another memory device.

The advantage of the emergency telephone according to the invention is that the replaceable memory device makes it possible to transmit new and/or additional functions and data to the emergency telephone. For example, a software and/or function update can be implemented easily and quickly, and/or the stored data can be updated or supplemented easily and quickly. The functions and data of the emergency telephone can therefore be advantageously tailored to the user of the emergency telephone. The emergency telephone can be used in a flexible manner at any time even if the user and/or application are changed. Particularly preferably, all data and functions that are required for normal operation are stored in the memory device so that, when the emergency telephone is replaced, the memory device from the previous emergency telephone can be installed in the new emergency telephone, thereby ensuring that all personalized data and functions, in particular, are still available.

A further advantage is that data and functions from the memory device can be transferred to a different memory device, thereby ensuring that data and/or functions can be backed up. It is thereby possible to prevent failure of the emergency telephone due to the loss of data and/or functions, and/or to restore the use of the emergency telephone easily and quickly by installing the other memory device.

According to a preferred embodiment of the invention, the memory device is designed as a memory card or a memory stick. The memory card preferably includes a non-volatile, permanent or semi-permanent memory. In particular, any type of data, such as text, images, audio and/or video, can be stored on the memory card. Possible variants of memory cards are compact flash (CF), memory stick (MS), multimedia card (MMC), secure digital memory card (SB) and/or smart media (SM). The memory stick is preferably a USB stick.

Preferably, a programming field comprising programming keys is disposed in the lower shell, the programming field being wired in a manner such that, when the programming keys are actuated, individual functions and/or data, and/or functions and/or data tailored to the user are stored on the memory device. It is also possible for programming instructions to be communicated to the programming person using a spoken message and/or a display disposed in the lower shell.

According to one possible embodiment, the functions stored in the memory device implement a user-specific setting of the emergency telephone. One possible user-specific setting relates to the output of spoken messages which the user initiates by operating the emergency telephone, wherein the spoken messages are also stored in the memory device. The spoken messages preferably prompt the user to actuate a certain key and/or provide feedback on which key the user has already pressed and which function it triggered or is triggering. As an alternative and/or in addition thereto, the feedback can be communicated to the user in a display that is integrated in the emergency telephone or on a screen that can be connected to the emergency telephone.

In the case of a further possible user-specific setting, the spoken message is output e.g. in the user's native language and/or using the voice and/or timbre of a person known by the user. In particular, a user-specific setting can also include voice control of the emergency telephone by the user, which is preferably learned or personalized for the user. It is also feasible for another user-specific setting to include the output of a periodically repeating spoken message that is tailored to the user.

According to a further possible embodiment of the invention, the functions include personalized messaging functions that are stored in the memory device. The personalized messaging functions are preferably tailored and/or tailorable to the user in an individualized manner. For example, the user is addressed personally using his own name in a spoken message by voice mail. It is possible for the messaging function to output a spoken message in a voice of a person who is known by the user and/or who is close to the user. The spoken messages can be e.g. instructions regarding a location where the user should go or where the user should stay. It is also feasible for the user to be reminded to take certain medication. It is feasible for the personalized messaging functions to output spoken messages that are transmitted to the user at individual times defined by the user. For example, the user can be prompted e.g. twice a day to press a certain key on the keyboard device in order to report back to the target address.

Preferably, the emergency telephone is connected or can be connected wirelessly to one or more output devices. In particular, the triggering device(s) also include an emergency call button. In general, the emergency telephone and the triggering device are designed to remain in contact and/or communicate with one another wirelessly. An alarm that is triggered by the triggering device is transmitted wirelessly to the emergency telephone and is forwarded from there via the telephone line to the target address. The triggering device can be designed as a mobile triggering device or a triggering device to be installed. The triggering device preferably includes a microphone and a loudspeaker for transmitting spoken messages that are preferably stored in the memory device of the emergency telephone and are output wirelessly to the triggering device. It is also possible for the spoken messages to be transmitted to the user by the emergency call center and for the user to be able to communicate with the emergency call center.

The mobile triggering device is preferably designed to be worn by the user on his body. The mobile triggering device is designed e.g. as a clip to be fastened to an article of clothing, as a necklace, or a wristband. The triggering device to be installed can be designed as a pull switch having a pull cord, or as an emergency wall tile having an emergency call button. They are installed e.g. in a bedroom or bathroom within reach of the user. The triggering device has the advantage that the user has access to the emergency call button and can trigger an alarm at any time in an emergency situation. For instance, the triggering device enables the user to obtain help immediately even if he is not close to an emergency telephone, or if the emergency telephone is out of reach. In particular, the user can also use at least a portion of the functions and/or data of the emergency telephone. Using the triggering device, the user can receive all of the spoken messages stored in the memory device, for instance.

According to a further embodiment of the invention, the functions include a function for identifying and/or locating the emergency telephone and/or the user. Preferably, the target address can also perform identification and/or location determination from an external perspective. In particular, the emergency telephone and/or the triggering device comprise an active or passive transmitter that can be identified and/or located by a receiving station that is separate and/or is spatially separated from the transmitter. In particular, an RFID chip is integrated in the emergency telephone and/or in the triggering device and/or in an identification mark. Using the RFID chip, the target address can identify and locate the emergency telephone and/or the user. It is feasible for the target address to be able to determine where the user is located. This is advantageous for demented persons in particular, who often have a difficult time finding their way to their destination once they leave their residence and/or room. By wearing the mobile triggering device, it is preferably also possible for a spoken message and/or a warning to be issued via the triggering device if the wearer leaves a certain location, the spoken message and/or warning notifying the user that he has left the location and/or instructing the user to not leave the location, or to return to it. It is also possible for a tracking module which locates the identification mark and/or the triggering device to be integrated in the emergency telephone.

According to a further embodiment of the invention, the data stored in the memory device include monitoring data. The monitoring data preferably include functionality data, event data, and/or continuous-operation data. The functionality data are, in particular, information regarding the functionality of the emergency telephone. According to a particularly preferred embodiment, the emergency telephone is designed to automatically conduct functionality tests at regular or irregular intervals, and to store the results in the form of functionality data in the memory device. For example, a battery status of the emergency telephone can be determined and stored.

The event data preferably include information on the use and/or activation of the emergency telephone. In particular, the emergency telephone is designed to record the nature and point in time of a user action and store them in the memory device. For example, the event data include information on a start-up or deactivation of the emergency telephone, such as the emergency telephone being switched on and off, or the operation thereof being interrupted due to a power failure or the battery being replaced, etc. It is also feasible for the emergency telephone to detect and store, in the memory device, the actuation of the emergency call button, a reply by the user to the target address, the user leaving his home environment, and/or the calling up or transmission of spoken messages, etc.

The continuous-operation data preferably comprise all data that are recorded in an operating mode and/or stand-by mode of the emergency telephone and are stored in the memory device. They typically also include the functionality data and event data.

The emergency telephone is preferably designed to record the data that are stored in the memory device, in particular the functionality data, event data, and/or continuous-operation data. In particular, a data record is created that notes a point in time, a duration, the user action, and/or a target address action. Preferably, the data record can be called up by the user and/or the target address. For instance, the memory device on which the data record is stored can be withdrawn from the emergency telephone and/or output using a suitable reading device. It is advantageous that the stored data record ensures that evidence is obtained since events and actions can be verified on and/or using the emergency telephone.

According to a further possible embodiment of the invention, the data stored in the memory device include user data. The user data preferably include personal data and medical data. The personal data are e.g. the name, address, telephone number, date of birth, etc. of the user. In particular, the personal data include information on and/or contact data for the family, nearby relatives, and/or the user's caregivers who should be notified e.g. in case of emergency. It is advantageous that the user can be identified quickly and easily by reading out the personal data from the memory device in case of accident and/or in an emergency situation, thereby making it possible for the proper persons to be contacted.

The medical data include, in particular, a health history e.g. a diagnosis of an illness that the user has, possible previous illnesses that the user has had, hospital stays, etc. In particular the medical data also include information on prescribed medication and the time at which they should be taken, and/or the contact information for the responsible physician or specialist. It is advantageous that help can be administered to the user quickly and effectively in case of emergency since all necessary medical data are stored on-site in the memory device and, given that the memory device is removable, can be called up and/or displayed using a suitable reading device.

According to a further possible embodiment of the invention, the functions include data security functions which are stored in the memory device. The emergency telephone is preferably designed to block the data, in particular the user data, from being called up and/or downloaded for improper use. In particular, unauthorized persons are denied access to the data that are stored in the memory device. In particular, spoken messages and/or voice mails are stored in a manner such that they have special protection. Preferably, the data, spoken messages, and/or voice mails are stored in an encoded manner or are stored in a separate local memory of the emergency telephone. It is also feasible to require that a password or PIN be entered in order to operate the emergency telephone. For instance, the password or PIN can be entered using certain spoken commands, speech recognition, and/or by entering a preselected combination of keys.

A further subject matter of the invention relates to a method for removing the memory device and reinstalling it in the emergency telephone, wherein the emergency telephone is preferably designed as described above and/or according to the preceding claims. First, the housing of the emergency telephone is opened without the use of tools and in a non-destructive manner, and then the memory device is removed from the housing. Next, new and/or additional data and/or functions are stored in the memory device. The data preferably include monitoring data and/or user data. In particular, the functions include the user-specific settings, the personalized messaging functions, and/or the identification of the emergency telephone and/or the determination of the location thereof. The memory device is then reinstalled in the housing and the housing is closed without the use of tools and in a non-destructive manner.

A further subject matter of the invention relates to a method for replacing the memory device by another memory device in the emergency telephone. Preferably, the emergency telephone is designed as described above and/or according to one of the preceding claims. First, the housing of the emergency telephone is opened without the use of tools and in a non-destructive manner, and then the memory device is removed from the housing. Next, a different memory device is installed in the housing. Preferably, the other memory device includes other, new, and/or additional data and/or functions. In particular, the data include monitoring and/or user data, and the functions include the implementation of user-specific settings, personalized messaging functions, and/or the identification of the emergency telephone and/or the determination of the location thereof. Finally, the housing is closed without the use of tools and/or in a non-destructive manner.

According to a preferred embodiment, the emergency telephone is reconfigured using one of the two methods described above. In particular, the emergency telephone is reconfigured by removing the memory device, storing new and/or additional data and/or functions in the memory device, and reinstalling the memory device in the housing. It is also feasible to remove the memory device from the housing and to replace it with a different memory device, wherein the other memory device includes other, new, and/or additional data and/or functions which thereby reconfigure the emergency telephone.

According to a further possible embodiment of the invention, the emergency telephone—which is referred to in the following as the first emergency telephone—can be easily replaced with a second emergency telephone as needed, in particular if the first emergency telephone becomes defective or fails. Given that the memory device is removed from the first emergency telephone and installed in the second emergency telephone, all of the data and functions of the first emergency telephone are preferably likewise available on the second emergency telephone and/or can be called up by the second emergency telephone.

It is advantageous that the second emergency telephone is fully operational once more as soon as the memory device from the first emergency telephone is installed in the second emergency telephone, and can be used immediately by a certain user. This is possible, in particular, since the second emergency telephone can also implement all of the functions that were already stored in the memory device for operating the first emergency telephone, in particular the functions that were tailored specifically for the user, and/or personalized messaging functions. Furthermore, the second emergency telephone includes all of the data that were stored previously in the memory device for operating the first emergency telephone, such as monitoring data and/or user data. It is particularly advantageous that the memory device of the first emergency telephone is the only thing needed to perform a user-specific configuration of the second emergency telephone before start-up, and that the second emergency telephone does not need to be programmed, which is a time-consuming procedure.

Further features, advantages, and effects of the invention result from the description that follows of preferred embodiments of the invention, and from the attached figures.

### BRIEF DESCRIPTION OF THE DRAWING

FIG. 1 a perspective view of an emergency telephone in accordance with the present invention;

FIG. 2 a top view of a lower shell of an emergency telephone, in accordance with the present invention;

FIG. 3 a block diagram of an emergency telephone comprising a triggering device in accordance with the present invention.

### DESCRIPTION OF THE PREFERRED EMBODIMENTS

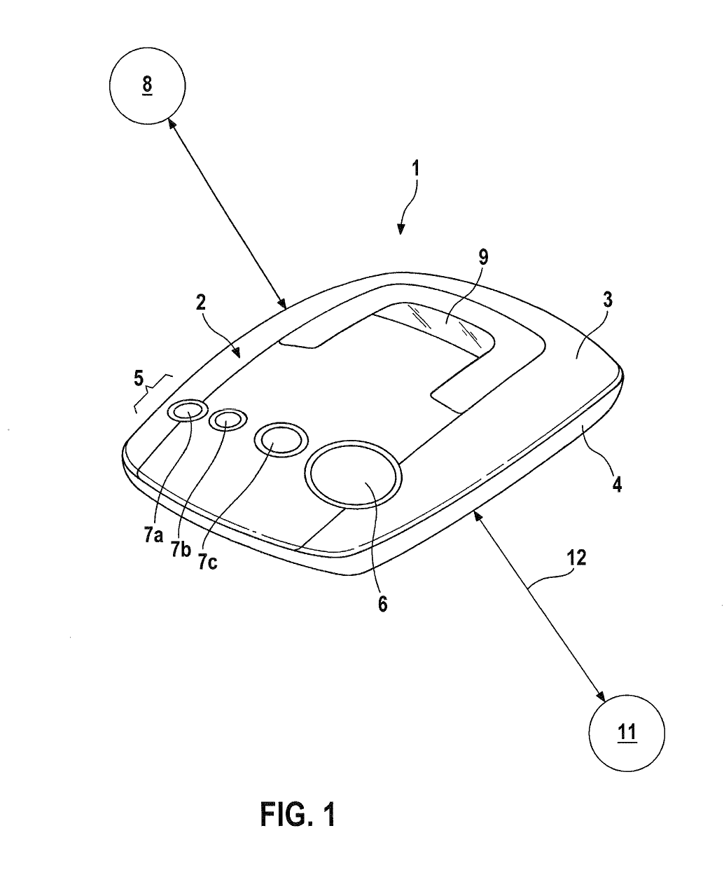

FIG. 1 shows an embodiment of the invention, in a perspective depiction of an emergency telephone 1. Emergency telephone 1 includes a housing 2 that comprises an upper shell 3 and a lower shell 4. Upper shell 3 and lower shell 4 are interconnected in a form-fit and/or non-positive manner, and are disposed such that they can be separated without the use of tools. Upper shell 3 includes an actuating device 5 which is fastened and/or integrated in upper shell 3. Actuating device 5 comprises an emergency call button 6 which is circular in design and red in color. Actuating device 5 also includes three further keys 7a; 7b; 7c which are designed to be much less conspicuous and have surface areas that preferably comprise up to 55%, in particular up to 65%, especially up to 75% of the surface area of emergency call button 6. Additional keys 7a; 7b; 7c are gray in color. Due to the color and size differences between additional keys 7a; 7b; 7c and emergency call button 6, the latter is clearly visible and is easy for a user 8 to find and actuate.

Upper shell 3 also comprises a window 9 that permits a view of a display 10 disposed in the interior of housing 2 in lower shell 4. Display 10 is designed to display information regarding the operation and functions of emergency telephone 1. For example, a display can be used to inform that the battery is low, whether emergency telephone 1 was started up or activated, whether emergency telephone 1 is in a stand-by mode, and/or whether a spoken message is ready to be picked up, etc.

Emergency call button 6 is designed to place and/or initiate an emergency call and/or alarm in an emergency call center 11 when actuated by user 8. When the emergency call and/or alarm is triggered, an optical warning signal is activated in emergency call center 11 and/or a spoken communication connection is established between user 8 and emergency call center 11. The spoken communication connection is established using a telephone line 12 which allows user 8 and emergency call center 11 to communicate with one another. Emergency telephone 1 includes a microphone and a loudspeaker, which are not depicted in FIG. 1, and which enable user 8 and emergency call center 11 to communicate with one another. Via the spoken communication connection, user 8 can communicate a reason for the emergency call and/or alarm to emergency call center 11. The reactions and replies from emergency call center 11 are then communicated to user 8.

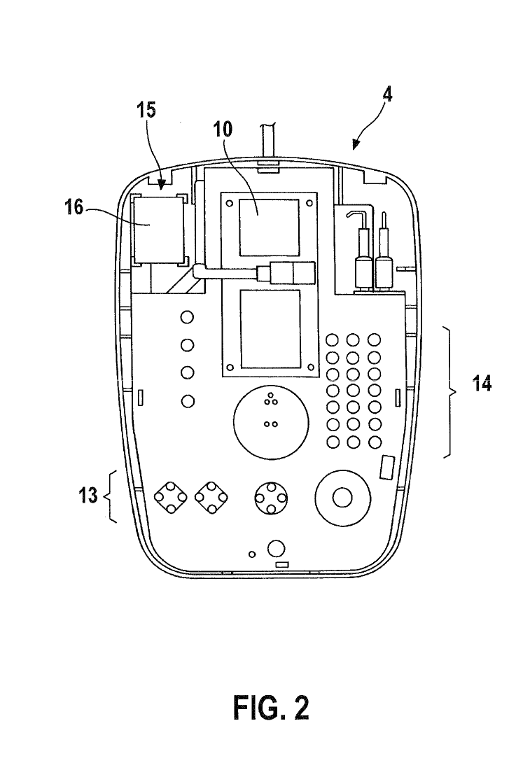

FIG. 2 shows a top view of lower shell 4 of emergency telephone 1 depicted in FIG. 1. Parts in the figures that are similar or are identical are labeled using the same reference characters. Lower shell 4 comprises an electronic circuit system 13 which is designed to be actuated by actuating device 5, in particular by emergency call button 6 and/or additional keys 7a; 7b; 7c.

A programming field 14 which includes programming keys is disposed in lower shell 4; programming field 14 is designed to enable emergency telephone 1 to be set up in a user-defined manner. When the programming field is actuated and emergency telephone 1 is set up in a user-defined manner, programming instructions automatically appear in display 10.

Lower shell 4 includes a receptacle 15 for a memory device 16 for storing data and functions. Memory device 16 is designed as a memory card. Receptacle 15 is substantially rectangular in design and is adapted to the dimensions of memory device 16. Memory device 16 is designed to be removed from and reinstalled in receptacle 15, or to be replaced by a different memory device, in a non-destructive manner, with housing 2 open.

Since memory device 16 is replaceable, it is possible to store new and/or additional data and functions in memory device 16, thereby supplementing and/or modifying the data and functions of emergency telephone 1.

The functions stored in memory device 16 include user-specific settings of emergency telephone 1, which are used to implement individual needs of user 8, and personalized messaging functions that are personally designed for user 8.

The user-specific settings includes spoken messages in the form of voice mail, which were stored specifically for user 8, and which are automatically communicated to user 8 at regular intervals. A further voice mail message that is stored in memory device 16 is played when user 8 or possibly another responsible person actuates a key in keyboard system 6 or programming field 14. The voice mail can support user 8 or the other responsible person as they operate and/or program emergency telephone 1. For example, voice mail is used to explain key functions and information regarding settings that were entered in emergency telephone 1. Provided that the appropriate function was stored in memory device 16, the voice mail can be communicated in the native language of user 8 and/or in a preferred timbre. As an alternative and/or in addition thereto, the explanation and information can also be displayed in display 9. A further user-specific setting that is likewise stored in memory device 16 is the voice control of emergency telephone 1 by the voice of user 8.

Due to the personalized messaging function stored in memory device 16, the spoken messages can be or are tailored individually to user 8. User 8 is spoken to personally using his own name in the voice of a familiar person and/or a person who is close to user 8. User 8 is prompted in the morning, afternoon, and evening to press key 7b to check in with emergency call center 11. Furthermore, user 8 receives regular reminders that prompt him or her to take medication at the proper time.

Furthermore, memory device 16 is designed to store user data. The user data is composed of personal data and medical data. The personal data include the name, address, telephone number, and date of birth of user 8, and the contact information for a person to notify in case of an accident. The medical data include a diagnosis of user 8, information on possible incompatibilities, the names and doses of medications to take, and the contact information for the responsible physician.

Emergency telephone 1 is designed to safeguard the user's data against misuse. A data security function is stored on memory device 16. The data security function encodes the user data and outputs it only after a certain key combination or voice command has been entered.

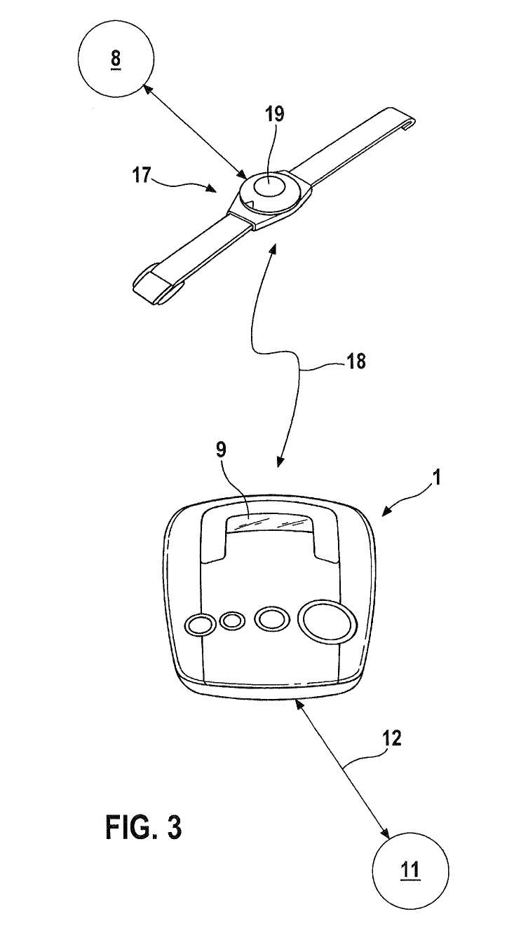

FIG. 3 shows a block diagram of emergency telephone 1 depicted in FIG. 1, which includes a mobile triggering device 17. Parts that are similar or identical in the figures are labeled using the same reference numerals. Emergency telephone 1 is connected to mobile triggering device 17 via a wireless connection 18. Mobile triggering device 17 is designed as a wristband and is suited to be worn by user 8 on the wrist. It comprises a microphone and a loudspeaker which are not depicted in FIG. 3.

Mobile triggering device 17 includes an emergency call button 19 which user 8 can use at any time to trigger an alarm and obtain help via wireless connection 18 to emergency telephone 1 and telephone connection 12 to emergency call center 11. Thus, user 8 can communicate with emergency call center 11 even if he is unable to reach emergency telephone 1 at the moment or is not located close to emergency telephone 1. Emergency telephone 1 is designed to wirelessly transmit the spoken messages stored in memory device 16 to user 8 via mobile triggering device 17.

Emergency telephone 1 includes the function for identifying and/or determining the location of emergency telephone 1, which is stored in memory device 16. Mobile triggering device 17 also includes this function. Emergency call center 11 can determine the location of emergency telephone 1 and mobile triggering device 17 using an RFID chip integrated therein, and assign them unequivocally to user 8. Since user 8 wears mobile triggering device 17 on the body, it is possible to determine the location of user 8 at any time. If emergency call center 11 determines that user 8 has left a certain location, emergency call center 11 transmits a spoken message via telephone line 12 to emergency telephone 1, prompting user 8 to return. The spoken message is forwarded to user 8 via wireless connection 18.

Memory device 16 is designed to store monitoring data of emergency telephone 1. The monitoring data are functionality data and event data on emergency telephone 1 and mobile triggering device 17. Emergency telephone 1 is designed to automatically perform a functionality test once a day on emergency telephone 1 and on mobile triggering device 17. A battery status is determined in particular. All events such as the response from user 8, the actuation of emergency call button 6, the transmission of spoken messages and/or voice mail, etc. are stored in memory device 16 in the form of event data.

Emergency telephone 1 is designed to record the stored monitoring and event data, and to store them as a data record in memory device 16. The data record notes the point in time and the event of the functionality test and displays all events on and/or using emergency telephone 1. The data record can be called up by user 8 and/or target address 1 after memory device 16 has been removed from housing 2.

It will be understood that each of the elements described above, or two or more together, may also find a useful application in other types of constructions differing from the types described above.

While the invention has been illustrated and described as embodied in an emergency telephone, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. An emergency telephone, comprising an emergency call button such that an emergency call is placeable by the emergency telephone to a target address in a manner selected from the group consisting of during actuation of said emergency call button, after actuation of said emergency call button, and both; a housing openable and closable at least partially in a manner selected from the group consisting of without use of tools, in a non-destructive manner, and both; and a memory device for storing functions and data, wherein said memory device is removable from said housing and also is reinstallable in said housing or replaceable by another memory device.

2. The emergency telephone as defined in claim 1, wherein said memory device is a device selected from the group consisting of a memory card and a memory stick.

3. The emergency telephone as defined in claim 1, wherein said memory device stores the functions which implement a user-specific setting of the emergency telephone.

4. The emergency telephone as defined in claim 1, wherein said memory device stores the functions which include personalized messaging functions.

5. The emergency telephone as defined in claim 1, wherein the emergency telephone is a telephone selected from the group consisting of an emergency telephone connected to a device selected from the group consisting of one triggering device and more triggering devices, and an emergency telephone connectible to a device selected from the group consisting of one triggering device and more triggering devices.

6. The emergency telephone as defined in claim 1, wherein the memory device store functions selected from the group consisting of an identification of the emergency telephone, an identification of the user, a determination of a location of the emergency telephone, and combinations thereof.

7. The emergency telephone as defined in claim 1, wherein the memory device is a memory device storing the data which include monitoring data.

8. The emergency telephone as defined in claim 1, wherein the memory device is a device which includes the monitoring data selected from the group consisting of functionality data, event data, continuous-operation data, and combinations thereof.

9. The emergency telephone as defined in claim 1, wherein the memory device is a device which stores the data in a data record in the memory device.

10. The emergency telephone as defined in claim 1, wherein the memory device is a memory device which stores the data including user data.

11. The emergency telephone as defined in claim 10, wherein the memory device is a device which includes the user data including personal data and medical data.

12. The emergency telephone as defined in claim 1, wherein the memory device is a device which stores the functions, including data security functions.

13. A method for removing and reinstalling a memory device in an emergency telephone defined in claim 1, comprising the steps of
opening the housing of the emergency telephone in the manner selected from the group consisting of without use of tools, in a non-destructive manner, and both;
removing the memory device from the housing;
storing elements elected from the group consisting of data, functions, and both which are elected from the group consisting of new, additional and both in the memory device;
reinstalling the memory device in the housing; and
closing the housing in a manner selected from the group consisting of without use of tools, in a non-destructive manner, and both.

14. A method for replacing a memory device with a different memory device in an emergency telephone defined in claim 1, comprising the steps of
opening the housing of the emergency telephone in a manner selected from the group consisting of without use of tools, in a non-destructive manner, and both;
removing the memory device from the housing;
installing a different memory device in the housing;
closing the housing in a manner selected from the group consisting of without use of tools, in a non-destructive manner, and both.

15. A method as defined in claim 13, and further comprising reconfiguring the emergency telephone using the method defined in claim 13.

16. A method defined in claim 14, and further comprising reconfiguring the emergency telephone using the method defined in claim 14.
